(19) United States
(12) Patent Application Publication
(10) Pub. No.: US 2014/0207585 A1
(43) Pub. Date: Jul. 24, 2014

(54) SIMPLIFIED CREATION OF ADVERTISEMENTS FOR A SOCIAL NETWORKING SYSTEM

(71) Applicant: Facebook, Inc., Menlo Park, CA (US)

(72) Inventor: Jordan Walke, Cupertino, CA (US)

(73) Assignee: Facebook, Inc., Menlo Park, CA (US)

(21) Appl. No.: 13/748,484

(22) Filed: Jan. 23, 2013

(51) Int. Cl. G06Q 50/00

(52) U.S. Cl. CPC G06Q 50/01; G06Q 30/0277
USPC 705/14.73

(57) ABSTRACT

An advertisement interface presents a single input field for creating advertisements using a social networking system. When input is received via the single input field, the social networking system determines whether the destination identified by the input is internal to or external to the social networking system. Based on the determination of identified destination, a set of options unique to the type of destination is presented. Based on the user's selection of options, an advertisement is created and presented to other users of the social networking system.

### BACKGROUND

This invention relates generally to social networking systems, and in particular to creating advertisements for users of a social networking system.

Social networking systems allow users to connect to and communicate with other users of the social networking system. Users create profiles on the social networking system that are tied to their identities and include information about the users, such as interests and demographic information. The users may be individuals or entities such as corporations or charities. Because of the increasing popularity of social networking systems and the significant amount of user-specific information maintained by social networking systems, a social networking system presents an ideal forum for targeted advertising.

Conventionally, different modes of advertising have been employed by social networking systems to provide users with different options for specifying advertisement performance depending on an advertisement's destination. The destination of an advertisement is a network location to which a user interacting with the advertisement is directed. For example, an advertisement destination may be a page or an application maintained by the social networking system or a web page or website external to the social networking system. Because different options for advertisement presentation and performance apply to advertisements with destinations internal to the social networking system and external to the social networking system, users of conventional social networking systems are required to choose a specify destination for an advertisement before creating and configuring the advertisement. This increases the complexity of advertisement creation and configuration.

### SUMMARY

A social networking system allows users to create advertisements for presentation to additional users using the social networking system. These advertisements may reach a large target audience and may be effectively targeted to users based on social and demographic information associated user profiles maintained by the social networking system. Advertisements may direct a user to content with a destination external to the social networking system. For example, accessing an advertisement directs a user to a web page outside of the social networking system. Advertisements may also be created to direct a user to content internal to the social networking system. For example, accessing an advertisement directs a user to a page, an application, or another object maintained by the social networking system. Conventionally, different modes of advertising have been provided by social networking systems for creating advertisements directing users to destinations internal to the social networking system or to destinations external to the social networking system. Additionally, configuration of advertisements for destinations internal to the social networking system may be limited to certain users, such as administrators of objects maintained by the social networking system.

To simplify advertisement creation, the social networking system determines whether a received input describing an advertisement is associated with an internal or external destination and provides advertising objects based on the determination. The social networking system determines the input identifies an object (e.g., a page, an application, etc.) internal to the social networking system and provides a set of options for creating an advertisement to direct users to the identified object. If the social networking system determines the input is a uniform resource locator (URL), or other identifying information, associated with a destination external to the social networking system, the social networking system provides a different set of options For generating an advertisement to direct users to the external destination.

In some embodiments, as the social networking system receives input, a list of candidate destinations both internal to and external to the social networking system matching a received portion of an input may be presented. This allows a user to identify a destination from the list without entering input completely specifying a destination. Various factors may be used to determine which destinations are included in the list of candidate destinations internal to the social networking system. For example, candidate destinations internal to the social networking system may be included on the list based on connections between the user and objects in the social networking system, based on objects for which the user has at least a threshold affinity, or based on any other suitable factors.

### BRIEF DESCRIPTION OF THE DRAWINGS

FIG. 1 is a block diagram of a system environment in which a social networking system operates, in accordance with an embodiment of the invention.

FIG. 2 is a block diagram of a social networking system, in accordance with an embodiment of the invention.

FIG. 3 is a flow chart of a method for creating an advertisement, in accordance with an embodiment of the invention.

FIGS. 4A and 4B are examples of an advertisement user interface in various states, in accordance with an embodiment of the invention.

FIG. 5 is an example advertisement user interface for an advertisement with a destination external to the social networking system, in accordance with an embodiment of the invention.

FIG. 6 is an example advertisement user interface for an advertisement with a destination internal to the social networking system, in accordance with an embodiment of the invention.

FIG. 7 illustrates an alternative advertisement user interface for an advertisement with a destination internal to the social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system allows users to create profiles associated with the users' demographic information and other social information, such as connections to other users, subscriptions, etc. Additionally, the social networking system allows users to create advertisements for presentation to other users. When the social networking system receives an input from a user to create an advertisement, the social networking system determines whether the input is associated with an advertisement that has a destination internal or external to the social networking system. Based on the determined type of destination, a set of options is provided to the user to customize the advertisement to achieve its intended objective. Different sets of options are associated with internal destinations and external destinations, so the user is presented with a different set of options based on the determined destination identified by the input.

### System Architecture

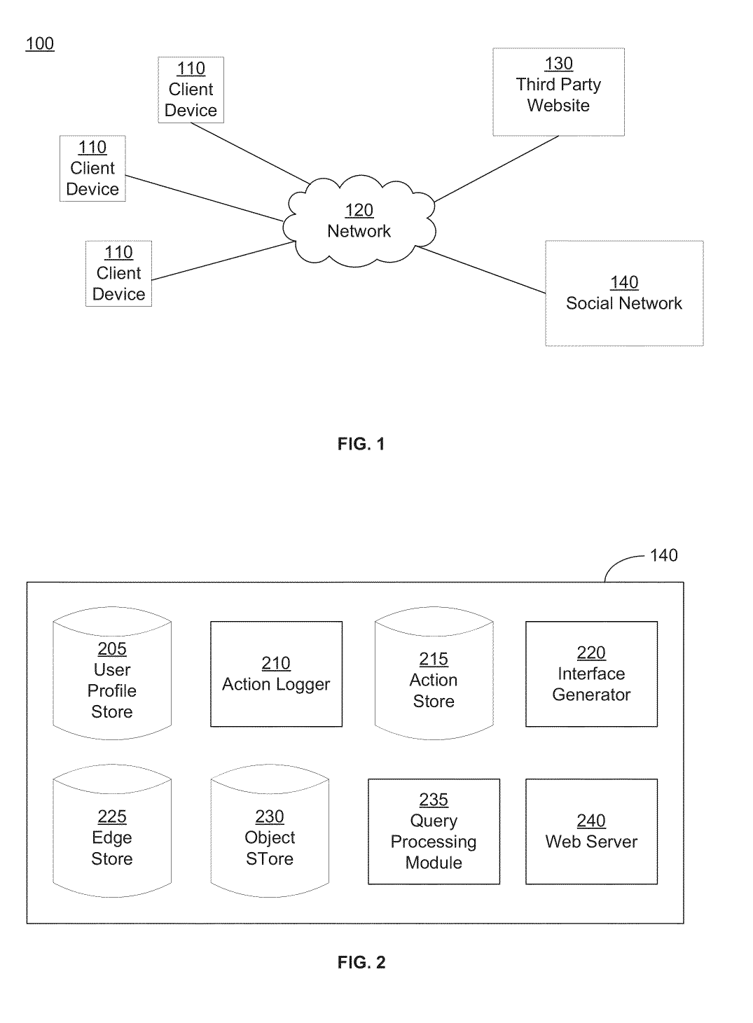

FIG. 1 is a high level block diagram illustrating a system environment 100 for a social networking system 140. The system environment 100 comprises one or more client devices 110, a network 120, one or more third-party websites 130, and a social networking system 140. In alternative configurations, different and/or additional components may be included in the system environment 100. The embodiments described herein can be adapted to online systems that are not social networking systems.

The client devices 110 comprise one or more computing devices capable of receiving user input as well as transmitting and/or receiving data via the network 120. In one embodiment, a client device 110 is a conventional computer system, such as a desktop or laptop computer. In another embodiment, a client device 110 may be a device having computer functionality, such as a personal digital assistant (PDA), mobile telephone, smart-phone or similar device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) that runs on the native operating system of the client device 110, such as IOS® or ANDROID™.

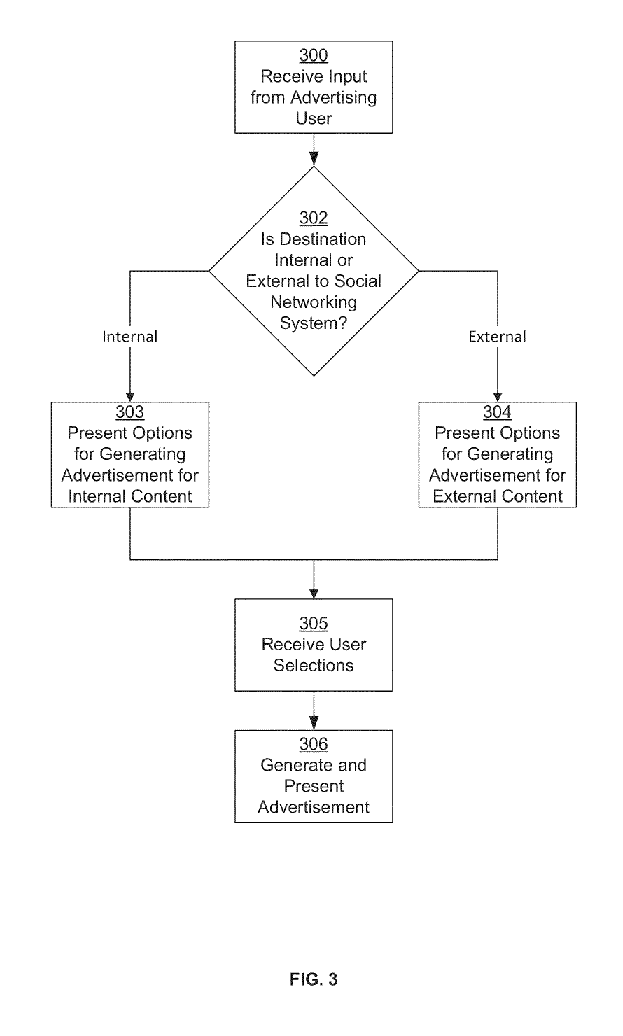

The client devices 110 are configured to communicate via the network 120, which may comprise any combination of local area and/or wide area networks, using both wired and wireless communication systems. In one embodiment, the network 120 uses standard communications technologies and/or protocols. Thus, the network 120 may include communication channels using technologies such as Ethernet, 802.11, worldwide interoperability for microwave access (WiMAX), 3G, 4G, CDMA, digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 120 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec). The third party website 130 may be coupled to the network 120 for communicating with the social networking system 140, which is further described below in conjunction with FIG. 2.

FIG. 2 is a block diagram of an example architecture of the social networking system 140. The social networking system 140 includes a user profile store 205, an action logger 210, an action store 215, an interface generator 220, an edge store 225, an object store 230, a query-processing module 235, and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user account and each user account typically is associated with a single user profile which is stored in the user profile store 205. A user profile includes declarative information about the user that was explicitly shared by the user, and may also include profile information inferred by the social networking system 140. A user profile may include multiple data fields, each data field describing one or more attributes of the corresponding user of the social networking system 140. The user profile information stored in the user profile store 205 describes the users of the social networking system 140, including biographic, demographic, and other types of descriptive information, such as work experience, educational history, gender, hobbies or preferences, location and the like and may also include data describing one or more relationships between a user and other users. A user profile store 205 may also store other information provided by the user, for example, images or videos. A user profile in the user profile store 205 may also maintain references to actions performed by the corresponding user that are stored in the action store 215.

While user profiles in the user profile store 205 are frequently associated with individuals, allowing people to interact with each other via the social networking system 140, user profiles may also be stored for entities such as businesses or organizations. This allows an entity to establish a presence on the social networking system 140 for connecting and exchanging content with other social networking system users. While an administrator or individual associated with the entity creates the user profile for the entity, the entity is identified as the account-hold associated with the user profile. The entity may post information about itself, about its products or provide other information to users of the social networking system 140 using a brand page associated with the entity's user profile. Other users of the social networking system 140 may connect to the brand page to receive information posted to the brand page or to receive information from the brand page. A user profile associated with the brand page may include information about the entity itself, providing users with background or informational data about the entity.

The action logger 210 receives communications describing user actions on and/or off the social networking system 140. The action logger 210 populates the action store 215 with information about user actions. When a user performs an action using the social networking system 140, the action logger 210 adds an entry to the action store 215. Such actions may include, for example, posting a comment on a page, sending a message to another user, posting a photo containing another user, changing relationship status with another user, attending an event posted by another user, among others. In addition, a number of actions described in connection with other objects are directed at particular users, so these actions are associated with those users as well. Some actions may be taken by users while not connected to the social networking system 140, and these actions may be logged and communication to the social networking system 140 when a connection is established.

The action store 215 maintains information describing actions by social networking system users internal to the social networking system 140, as well as actions performed via third party websites 130 that communicate information to the social networking system 140. Users may interact with various objects maintained by the social networking system 140, and these interactions are stored in the action log 215. Examples of actions stored by the action store 215 include: commenting on posts, sharing links, and checking-in to physical locations via a mobile device or other client device 110. Additional examples of interactions with objects on the social networking system 140 included in the action store 215 include commenting on a photo album, communications between users, becoming a fan of a musician, adding an event to a calendar, joining groups, becoming a fan of a brand page, creating an event, authorizing an application, using an application, interacting with an advertisement and engaging in a transaction.

The interface generator 220 allows a social networking system user to interact with the social networking system 140. For example, the interface generator 220 generates one or more web pages including content from the social networking system 140, such as images, video, profile information, or other data. The interface generator 220 also generates one or more interfaces allowing the social networking system 140 to request information from users and for users to provide information to the social networking system 140 via a client device 110 and the network 120. For example, the interface generator 220 may creates a form for a user to provide biographic information, such as the user's age, for use by the social networking system 140 for creating a user profile. When other users request a user's profile page, the interface generator 220 retrieves data from the profile store 205 and generates a representation of the information in the user profile for display on the client device 110.

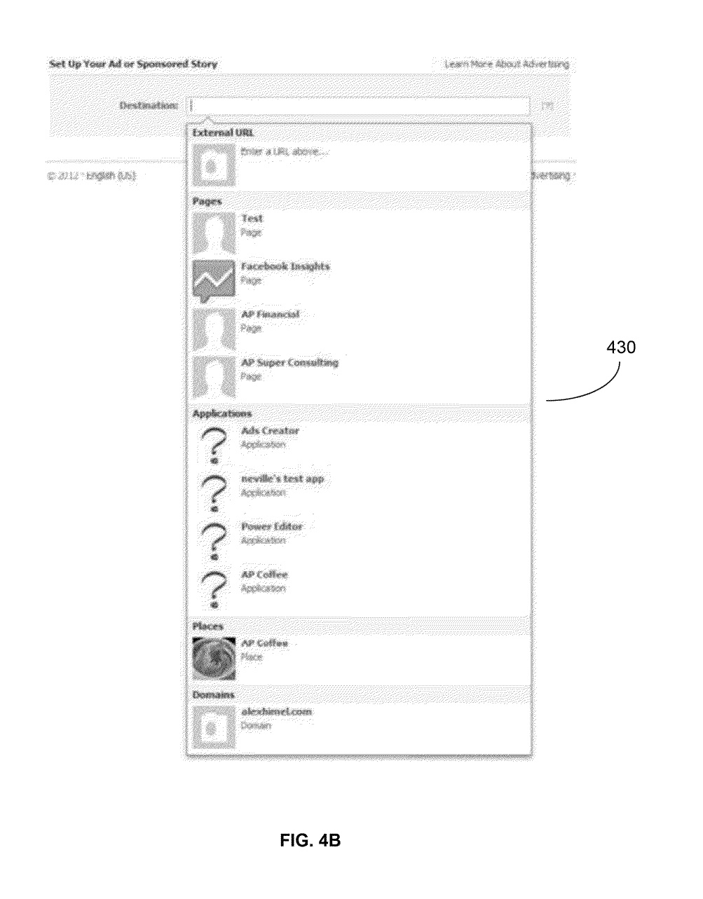

The interface generator 220 also generates an advertisement user interface, which allows users to provide the social networking system 140 with information to create an advertisement. For example, the advertisement user interface includes a single input field in which users may provide an input identifying a destination associated with an advertisement; after determining whether the destination is internal to the social networking system 140 or external to the social networking system 140, the advertisement interface presents additional options selected based on the determination. In one embodiment, the advertisement user interfaces generated by the interface generator 220 are built using an existing set of application programming interfaces (APIs) for an advertising engine of the social networking system 140 that receives the requests to create advertisements from users. Presentation of options based on the destination associated with an advertisement is further described below in conjunction with FIGS. 4A-7.

The edge store 225 includes information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Generally, establishing a connection to a user in a social networking system 140 allows access to more information about the user to which the connection was established than would be available to unconnected users. For example, although privacy settings limit access to information in a user profile, when an additional user establishes a connection with the user, the additional user may access an increased amount of information in the user profile. Other edges are generated when users interact with objects in the social networking system 140, such as expressing interest in a page on the social networking system 140, sharing a link with other users of the social networking system, and commenting on posts made by other users of the social networking system 140. These edges may be visible to other social networking system users. Multiple interactions between a user and an object may be stored in a single edge in the edge store 225. In other embodiments, each interaction between a user and an object is stored as a separate edge. In some embodiments, connections between users may be stored in the user profile store 205, or the user profile store 205 may access the edge store 225 to determine connections between users.

The object store 230 stores information about content maintained by the social networking system. Different content items, which represent individual pieces of content provided by the social networking system 140 to users, are stored as objects in the object store 230. Examples of objects include applications (e.g., a game playable within the social networking system), events (e.g., a concert that users may attend), groups to which users may belong, pages or hubs (e.g., pages constituting a particular organization's presence on the system), media items (e.g., pictures, videos, audio, text, or any other type of media content), locations associated with a user (e.g., “Santa Clara, Calif., USA”), and even concepts or other terms (e.g., “Victorian literature”), or other suitable data presented to users. The object store 230 may also store objects representing other data routinely produced by users of the social networking system 140, such as inbox messages, status updates, photos, videos, comments, notes, and postings. An object in the object store 230 may represent an entity existing within the social networking system (e.g., an application available on the social networking system), a virtual entity existing outside the domain of the social networking system (e.g., a website), or a real-world entity (e.g., a sports team or a retail store).

The object store 230 may data for generating content presented to social networking system users, such as the code of an application or the image data associated with an image media item. Alternatively, for objects representing entities outside of the social networking system 140, the object store 230 includes a pointer or a reference to a destination associated with the entities, such as the uniform resource locator (URL) of an external media item. Additionally, the object store 230 may also store metadata associated with the objects, such as a name describing the object (e.g. “Charles Williams” for a page for a person, “Birthday Reminder” for an application, or “Penguin Fanciers” for a group), an image representing the object (e.g., a user profile picture), or one or more tags assigned to the object by users (e.g. the textual strings “game,” “crime,” and “strategy” for a strategy game application). Different types of objects may have different types of metadata, such as a set of associated users for a group, a media type (e.g., “video”) for a media item object, and a unique user ID and name tokens (e.g., separate first and last names “Charles” and “Williams”) for a an object representing a person.

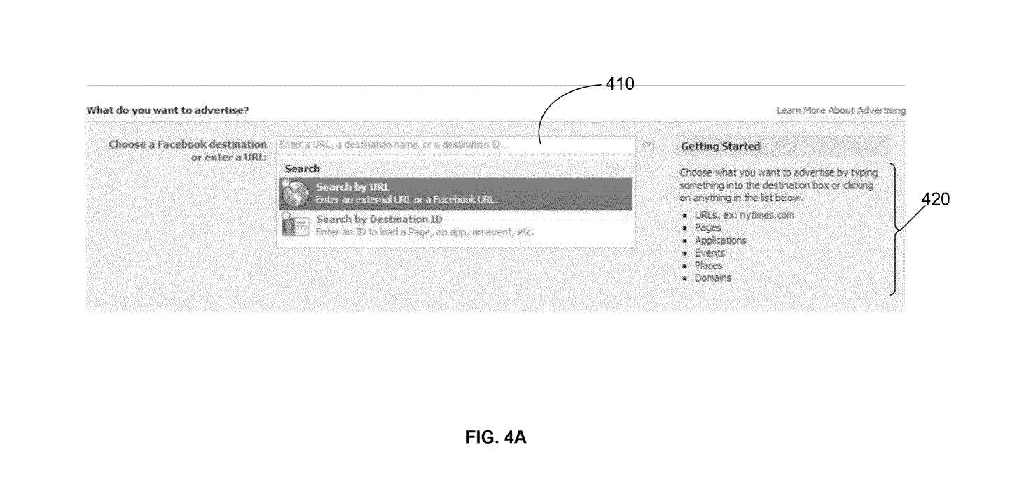

The query processing module 235 processes input received from a user via an advertising interface. A destination associated with the received input is determined using text-parsing technology and structured data to identify one or more destinations that may be internal to or external to the social networking system 140 from the input. In one embodiment, the query processing module 235 generates a list including candidate destinations that are internal or external to the social networking system 140 that match the received portion of the input. The query processing module 235 may limit identification of a destination for received input to objects associated with the user providing the input by the object store 230. The query processing module 235 identifies objects associated with the received input using one or more search processes, combines the results from the search processes, and filters and orders the combined results to produce the list including candidate destinations. The query processing module 235 is further described below in conjunction with FIGS. 3-4B.

The web server 240 links the social networking system 140 via the network 120 to the one or more client devices 110, as well as to the one or more third party websites 130. The web server 240 serves web pages, as well as other web-related content, such as JAVA®, FLASH®, XML and so forth. The web server 240 may provide the functionality of receiving and routing messages between the social networking system 140 and the client device 110, for example, instant messages, queued messages (e.g., email), text and SMS (short message service) messages, or messages sent using any other suitable messaging technique. A user may send a request to the web server 240 to upload information, for example, images or videos that are stored in the object store 230. Additionally, the web server 240 may provide API functionality to send data directly to native client device operating systems, such as IOS®, ANDROID™, WEBOS® or RIM.

### Advertisement Creation Overview

FIG. 3 illustrates one embodiment of a method for creating an advertisement. When the social networking system 140 receives an input 300 from a user to create an advertisement, the query processing module 235 determines 302 a type of network destination identified by the input associated with the received input. The destination identified by the input refers to the source of the content presented to a user accessing an advertisement associated with the input. In one embodiment, the query processing module 235 determines 302 if the input identifies a destination internal to the social networking system 140 (an “internal destination”) or a destination external to the social networking system 140 (an “external destination”). For example, the query processing module 235 determines 302 if the destination identified by the input is an object maintained by the social networking system 104 (an internal destination) or is a uniform resource locator (URL) identifying a third party website 130 (an external destination).

Depending on whether the query processing module 235 determines 302 that the destination is internal or external to the social networking system 140, different sets of options are provided to the user for customizing the advertisement. If the query processing module 235 determines 302 that the input identifies an internal destination, options for configuring an advertisement accessing an object maintained by the social networking system 140 are presented 303. Examples of options for configuring an advertisement associated with an internal destination include: an objective for increasing users expressing a preference for a page, an objective for increasing a number of posts to a page, an objective for increasing a number of users associated with the page, an objective for increasing application engagement, options for specifying characteristics of an audience, budget specification, or other suitable options.

If the query processing module 235 determines 302 that the destination identified by the input is external to the social networking system 104, a different set of options for configuring an advertisement associated with an external destination are presented 304. Examples of options for configuring an advertisement associated with an external destination include: adding a headline, adding text, adding an image, identifying additional web pages associated with the advertisement, specifying characteristics of an audience, specifying a budget, or other suitable options. After receiving 305 selections for one or more of the presented options, the interface generator 220 generates the advertisement based on the input and the selected option. The generated advertisement is subsequently presented 306 to other users of the social networking system 140.

### Determining Destination

FIGS. 4A and 4B show examples of an advertisement user interface in various states, according to an embodiment. In the example of FIG. 4A, the interface generator 220 generates a user interface having a single input field 410 for creating an advertisement. Input is provided to the social networking system 140 via the single input field 410. The input identifies the content and destination of an advertisement. The input received via the single input field 410 is communicated to the query processing module 235, which associates different types of inputs with different types of destinations using text-parsing technology and structured data. Examples of types of destinations associated with types of input by the query processing module 235 include external URLs, pages, applications, events, places, and domains 420. Characteristics of the input, such as its formatting, may be used to identify a type of destination associated with the input. For example, an input of “cnn.com” is determined to identify a destination external to the social networking system 140.

In one embodiment, the advertisement user interface provides a user with a list of candidate destinations 430 that are internal and/or external to the social networking system 140 matching the received portion of the input. The candidate destinations 430, shown in FIG. 4B, may be modified as additional portions of the input are received, allowing the list to dynamically modify the presented candidate destinations 430. A user may select a candidate destination from the list to further simplify advertisement creation. In one embodiment, candidate destinations 430 are identified using text-parsing technology and structured data. The selectable list of candidate destinations 430 may indicate the destination type associated with each candidate destination.

The query processing module 235 may operate in a user-specific context when a user is logged into the social networking system 140. In a user-specific context, the query processing module 235 leverages information stored about the user in the user profile store 205, action store 215, edge store 225, and/or about the various objects in the object store 230 to predict one or more objects likely to be of interest to the user based on the received portion of the input in the single input field 410. For example, if a user has created a connection to APPLEBEE'S® restaurant, candidate destinations associated with APPLEBEE'S® may be included in the selectable list of candidate destinations 430 when “Apple” is entered into the single input field 410. Retrieval of objects stored by a social networking system 140 in response to a query is further disclosed in U.S. application Ser. No. 12/816,377, filed on Jun. 15, 2010, issued as U.S. Pat. No. 8,239,364, which is incorporated herein by reference in its entirety.

Candidate destinations 430 internal to the social networking system 140 may be identified based on objects in the social networking system 140 for which the user has at least a threshold affinity. For example, if a user has created a connection to an object associated with APPLEBEE'S® restaurant (through a single check-in indicating a visit to the restaurant) and a connection to an object associated with APPLE® Inc. (through liking an associated page and posting several comments on the page), the selectable list of candidate destinations 430 may select an object based on the affinity of the user for the different objects. For example, an object is not selected as a candidate destination unless the user has at least a threshold affinity for the object. The threshold affinity may be set by the social networking system 140 and specifies a minimum affinity of a user for an object before the query processing module 235 includes the object in the list of candidate destinations 430. The query processing module 235 may identify the objects according to different search algorithms, combines the results from the algorithms, and filters and orders the objects of the combined results.

### Advertisement Customization Options

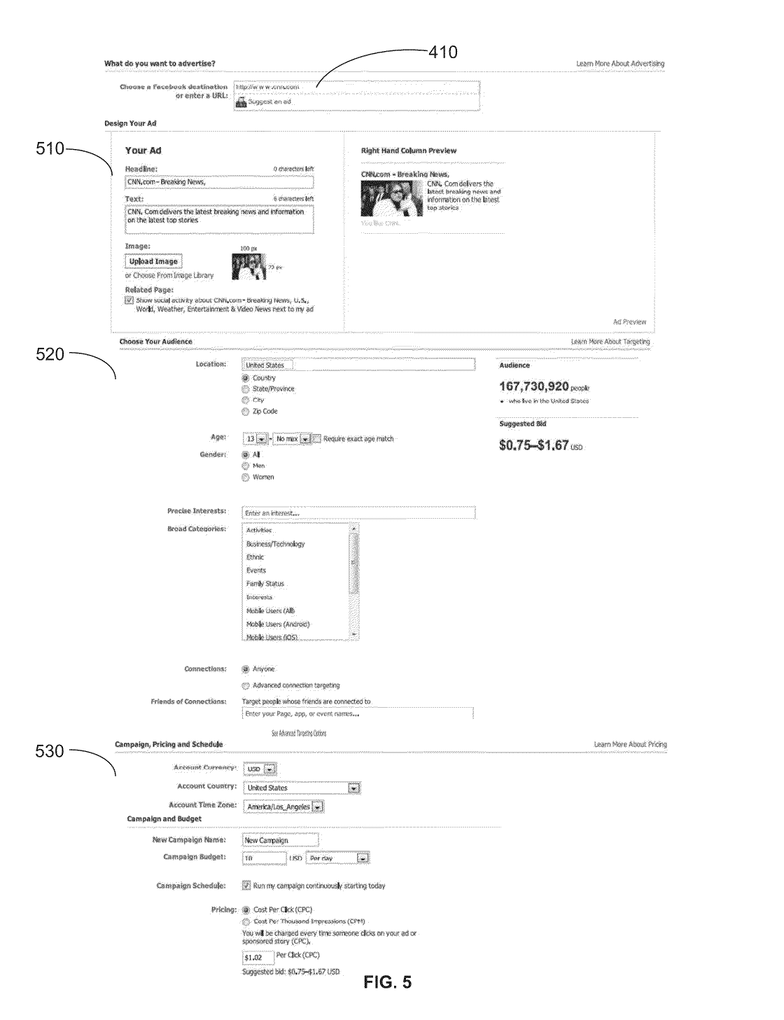

Depending on whether the query processing module 235 determines that a destination identified by an input is internal or external to the social networking system 140, different sets of options are provided to the user to customize the advertisement. FIG. 5 shows an example of options presented to a user if an input is determined to identify a destination external to the social networking system 140. In the example of FIG. 5, the interface generator 220 provides a set of options for customizing an advertisement having an external destination. Examples of options include options for designing the advertisement 510 including adding a headline, text, an image, and/or a related page to the advertisement. A preview of the advertisement generated using specified options may also be shown. Another set of presented options allow specification of audience characteristics 520 including selecting audience location, age, gender, interests, and connections. Budgeting options 530 are also presented. Examples of budgeting options 530 include selections of one or more of currency, country, time zone, campaign name, campaign budget, campaign schedule, and pricing (e.g., bid amounts)

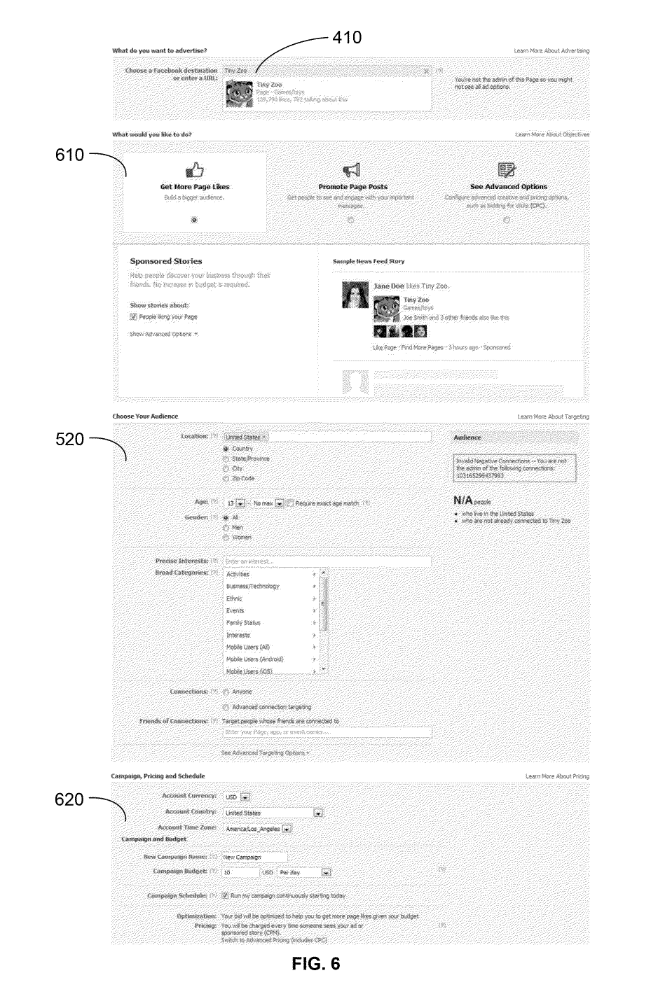

If the query processing module 235 determines that the destination identified by an input is an object internal to the social networking system 140, such as a page, a different set of options for customizing an advertisement are presented, as shown by FIG. 6. Options for customizing an advertisement for an internal destination may include options for choosing an objective of the advertisement 610, such as increasing a number of social networking system users indicating a preference for the page, increasing an amount of information posted to the page, and generating one or more stories associated with the page. A preview of the generated advertisement based on the selected options may also be shown. Additional options may also be presented. For example, options related to selecting an audience 520 as described above, and/or budgeting options 620, as described above, may also be presented.

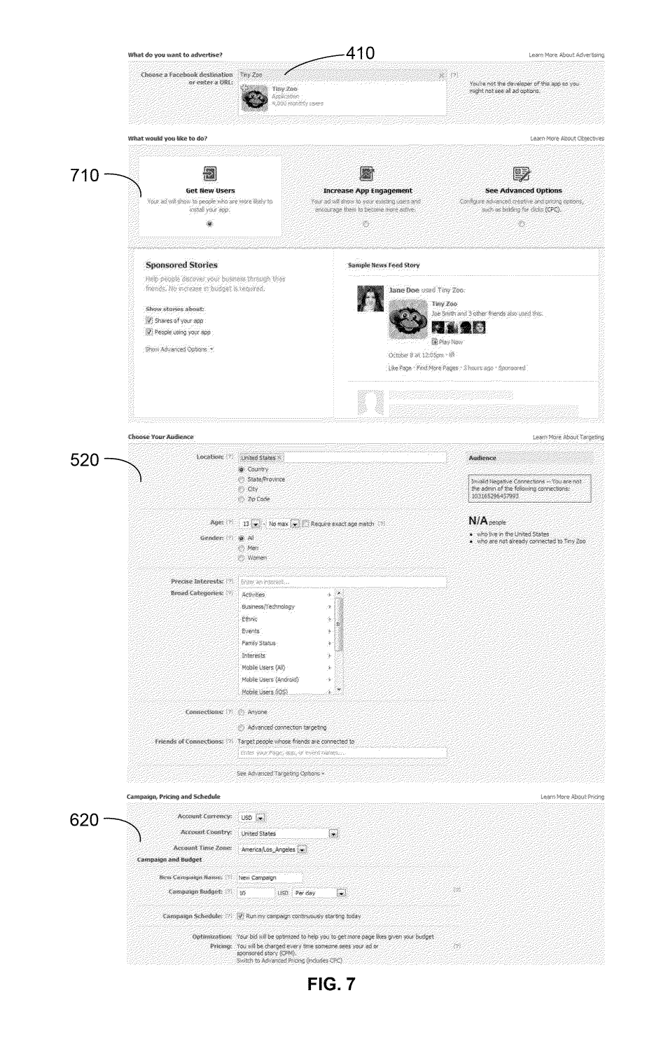

In one embodiment, as illustrated in FIG. 7, if the query processing module 235 determines that the destination identified by the input is an application object within the social networking system 140, a set of corresponding options is generated by the interface generator 220. Examples of options presented for an advertisement identifying an application include options for specifying an objective 710 of the advertisement. Example objectives of the advertisement include: getting new users of the application, increasing the amount of interaction with the application, and generating one or more stories associated with the application. A preview of the advertisement generated by selected options may be shown. As described above, options for selecting an audience 520 and/or budgeting options 620 may also be presented.

Budgeting options 620 allow a user to specify how the user is charged by the social networking system 140 for presentation of advertisements. For example, a user selects an option to be charged each time another user interacts with the advertisement or each time the advertisement is displayed to another user. Depending on the selected method for charging the user, a corresponding option for the user to enter an amount to be charged for each interaction or display is presented, with a higher amount corresponding to a greater frequency with which the advertisement will be displayed. In one embodiment, the user may specify a method for being charged, but the amount charged is set by the social networking system 140 to optimize the advertisement's engagement with other users, depending on a specified budget.

In another embodiment, some or all of the options described above for each of the destinations are automatically populated by the social networking system 140. For example, options regarding currency, country, and time zone may be preselected to be United States Dollars, United States, and America/Los Angeles by the social networking system 140 when the social networking system 140 detects that a user is creating an advertisement while located in Los Angeles. The social networking system 140 may allow the user to change some or all of these options.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving an input from an user of a social networking system;
determining whether the input identifies a destination external to the social networking system or a destination internal to the social networking system;
responsive to determining the input identifies the destination external to the social networking system, presenting options selected from a set of options for generating an advertisement for content external to the social networking system;
responsive to determining the input identifies the destination internal to the social networking system, presenting options selected from a set of options for generating an advertisement for content internal to the social networking system, the set of options for generating the advertisement for content internal to the social networking system different than the set of options for generating the advertisement for content external to the social networking system; and
generating an advertisement based on one or more presented options selected by the user.

2. The method of claim 1, wherein the destination internal to the social networking system comprises an object maintained by the social networking system.

3. The method of claim 2, wherein the object maintained by the social networking system comprises a page.

4. The method of claim 1, wherein at least one of the presented options from the set of options for generating an advertisement for content internal to the social networking system identifies an objective for interacting with the content internal to the social networking system.

5. The method of claim 4, wherein the objective is selected from a group consisting of: increasing a number of social networking system users indicating a preference for the content internal to the social networking system, increasing an amount of information posted to the content internal to the social networking system, increasing an amount of interaction with the content internal to the social networking system, generating one or more stories associated with the content internal to the social networking system, and any combination thereof.

6. The method of claim 4, wherein the content internal to the social networking system is a page or an application.

7. The method of claim 1, wherein determining whether the input identifies the destination external to the social networking system or the destination internal to the social networking system comprises:
determining whether the input identifies a uniform resource locator associated with a system external to the social networking system.

8. The method of claim 1, wherein the set of options for generating an advertisement for content external to the social networking system includes options for specifying one or more selected from a group consisting of: a headline, text, an image, a related page, and any combination thereof.

9. The method of claim 1, wherein determining whether the input identifies a destination external to the social networking system or a destination internal to the social networking system comprises:
responsive to receiving a portion of the input, presenting one or more candidate destinations matching the received portion of the input, the candidate destinations including destinations internal to the social networking system and destinations external to the social networking system.

10. The method of claim 9, wherein the candidate destinations are based in part on connections between the user and objects in the social networking system.

11. The method of claim 10, wherein the candidate destinations include objects in the social networking system connected to the user and for which the user has at least a threshold affinity.

12. A method comprising:
receiving an input from a user of a social networking system;
determining whether the input identifies a destination external to the social networking system or a destination internal to the social networking system;
responsive to determining the input identifies the destination external to the social networking system, presenting options selected from a set of options for generating an advertisement for content external to the social networking system; and
responsive to determining the input identifies the destination internal to the social networking system, presenting options selected from a set of options for generating an advertisement for content internal to the social networking system, the set of options for generating the advertisement for content internal to the social networking system different than the set of options for generating the advertisement for content external to the social networking system.

13. The method of claim 12, further comprising:
generating an advertisement based on one or more of the presented options selected by the user; and
presenting the generated advertisement to users of the social networking system.

14. The method of claim 12, wherein the destination internal to the social networking system comprises an object maintained by the social networking system.

15. The method of claim 14, wherein the object maintained by the social networking system comprises a page or an application.

16. The method of claim 12, wherein at least one of the presented options from the set of options for generating an advertisement for content internal to the social networking system identifies an objective for interacting with the content internal to the social networking system.

17. The method of claim 16, wherein the objective is selected from a group consisting of: increasing a number of social networking system users indicating a preference for the content internal to the social networking system, increasing an amount of information posted to the content internal to the social networking system, increasing an amount of interaction with the content internal to the social networking system, generating one or more stories associated with the content internal to the social networking system, and any combination thereof.

18. The method of claim 12, wherein determining whether the input identifies the destination external to the social networking system or the destination internal to the social networking system comprises:
determining whether the input identifies a uniform resource locator associated with a system external to the social networking system.

19. The method of claim 12, wherein the set of options for generating an advertisement for content external to the social networking system includes options for specifying one or more selected from a group consisting of: a headline, text, an image, a related page, and any combination thereof.

20. The method of claim 12, wherein determining whether the input identifies a destination external to the social networking system or a destination internal to the social networking system comprises:
determining whether the input includes one or more characteristics associated with a uniform resource indicator.

21. The method of claim 12, further comprising:
responsive to determining the input identifies the destination external to the social networking system, generating an object associated with the destination external to the social networking system and storing the generated object in the social networking system.
